(19) United States
(12) Patent Application Publication
(10) Pub. No.: US 2023/0385492 A1
(43) Pub. Date: Nov. 30, 2023

(54) Method for reconstructing physical connection relationships of general EDA model layouts

(71) Applicant: Xpeedic Co., Ltd., Shanghai (CN)

(72) Inventors: Yunzhu DU, Shanghai (CN); Feng LING, Shanghai (CN); Wenliang DAI, Shanghai (CN); Liguo JIANG, Shanghai (CN); Yan LV, Shanghai (CN); Zhichao GU, Shanghai (CN)

(21) Appl. No.: 18/249,571

(22) PCT Filed: Mar. 16, 2021
(86) PCT No.: PCT/CN2021/081171

§ 371 Date: Apr. 19, 2023

(30) Foreign Application Priority Data
Oct. 20, 2020 (CN) 202011128432.2

(51) Int. Cl. G06F 30/31; G06F 30/392

(52) U.S. Cl. CPC G06F 30/31; G06F 30/392

(57) ABSTRACT

A method for reconstructing physical connection relationships of general EDA model layouts comprising: separately establishing interconnection relationships between stack layers in an EDA model, connection relationships of graphics on each stack layer, and connection relationships of graphics on interconnected stack layers; summarizing the connection relationships established, and then establishing connection relationships of all graphics of an overall EDA model; and separately establishing physical connection relationships of interconnected graphics in each group to obtain physical connection relationships of the overall EDA model layout. The determination of connection relationships of the EDA model is converted into the determination of intersection relationships of pure two-dimensional graphics, and temporal complexity of the two-dimensional graphic intersection relationships is lowered by means of a divide-and-conquer algorithm, thereby fulfilling the objective of quickly establishing connection relationships, solving the problem that specific link information cannot be accurately extracted from a model in layout pre-processing during a simulation process.

### TECHNICAL FIELD

The present invention belongs to the technical field of EDA model layout simulation, in particular to a method for reconstructing physical connection relationships of general EDA model layouts.

### BACKGROUND TECHNOLOGY

Radio frequency integrated circuits refer to radio frequency circuits manufactured by using semiconductor integrated circuit technology, which are characterized in small size, low power consumption, and high reliability. Common radio frequency circuits include low noise amplifiers, power amplifiers, oscillators and mixers, etc., with operating frequencies ranging from hundreds of MHz to several GHz and dozens of GHz, and are a very important kind of signal processing modules of wireless communication equipment, so that performance thereof directly affects product quality.

In recent years, wireless communication technology has developed rapidly, and wireless products are widely used in all aspects of people's lives. Higher requirements have been put forward for radio frequency integrated circuits, which require better signal processing capabilities and shorter product development cycles.

For a chip, good layout and wiring will save area, improve signal integrity and stability, and directly improve chip reliability, so EDA (Exploratory Data Analysis) software is very important for chip design. Before chip Tapout, how to effectively verify whether the chip design meets requirements can greatly reduce the number of iterations in the design and reduce the design time. However, traditional physical circuit design models are limited by two-dimensional views thereof, so it is difficult for designers to intuitively design the physical circuits during design operations, and designers often need to spend a lot of time switching among various levels in physical circuits. Even in this way, it is difficult to directly compare relationships between layers in physical circuits, and the results are equally ineffective for optimizing circuit parameters and circuit layout. How to automatically extract chain circuits that designers are concerned about is a key step in an entire design process.

After retrieval, a Chinese application for invention patent entitled “method for accelerating generation of conductor graph connection relationships in layouts” is found (with application number of 201710103731.2, filed in Feb. 24, 2017), comprising steps of: (1) determining an initial trace graphic; (2) tracing graphics in other conductive layers that are at a same level as or directly connected to the initial trace graphic, adding the traced graphics to a result queue; (3) tracking via layer graphics connected with the initial tracking graphics, grouping the via layer graphics tracked, tracking conductive layer graphics connected with each group of via layer graphics, and adding the tracked conductive layer graphics to the result queue; (4) performing steps (2) and (3) with conductive layer graphics in the result queue as initial trace graphics sequentially; and (5) collecting all conductive layer graphics and via layer graphics to form a complete wire mesh. In the mentioned application, for multi-level large-scale perforated connections, it is possible to reduce the number of searches for connecting conductive layer graphics, reduce the number of times for checking whether the graphics overlap, and improve the efficiency of line network tracking. However, a shortcoming of the mentioned application is that it is difficult to fully judge connection relationships of all graphics.

### SUMMARY OF THE INVENTION

### 1. Technical Problems to be Solved in the Present Invention

The present invention aims to solve the problem that it is difficult to quickly and comprehensively identify connection relationships of all graphics in existing chip layouts.

### 2. Technical Solutions

In order to achieve above purpose, the present invention provides following technical solutions:

A method for reconstructing physical connection relationships of general EDA model layouts of the present invention comprises: separately establishing interconnection relationships between stack layers in an EDA model, connection relationships of graphics on each of the stack layers, and connection relationships of graphics on interconnected stack layers; summarizing the connection relationships established, and then establishing connection relationships of all graphics of an overall EDA model; and separately establishing physical connection relationships for interconnected graphics in each group to obtain physical connection relationships of the overall EDA model layout.

Preferably, the method for reconstructing physical connection relationships of general EDA model layouts comprises following steps of:
S100—establishing interconnection relationships between stack layers according to a stackup file of an EDA model;
S200—establishing graphic connection relationships of graphics on each stack layer;
S300—selecting graphics that are connected on adjacent stack layers to establish the graphic connection relationships;
S400—establishing connection relationships of all graphics of an overall EDA model layout according to the graphic connection relationships obtained in steps S200 and S300;
S500—grouping graphics having the connection relationships and establishing physical connection relationships among groups; and
S600—summarizing the physical connection relationships of all the groups to obtain the physical connection relationships of the overall EDA model layout.

Preferably, the graphic connection relationships of all graphics in steps S200 and S300 are established specifically through following steps of:
step (1)—preprocessing all graphics and calculating bounding boxes of all graphics, referred to as bbox;
step (2)—putting all graphics together to generate a graphic set and calculating the bbox of the graphic set;
step (3)—partitioning the bbox of the graphic set into two subsets along a central x-axis or y-axis of the bbox of the graphic set in a partitioning manner that a sum of amount of graphics in the two subsets after being partitioned reaches a minimum value;
step (4)—separately judging whether to continue to partition the two subsets partitioned is possible, if yes, skipping to step (2) to continue partitioning; and if no, executing step (5);
step (5)—judging whether there are interconnected graphics in different subsets, if yes, recording relationships of intersected subsets, and obtaining connection relationships of the subsets after judging and recording relationships of all intersected subsets;
step (6)—merging subsets having connection relationships and generating connection relationships of parent sets;
step (7)—judging whether there is any of the parent sets connecting to other subsets, if yes, continuing to merge until generating a final parent set that connects to no subset; and
step (8)—finishing merging all subsets when the final parent set is the same as the graphic set generated by putting all original graphics together, i.e., finishing establishing connection relationships.

Preferably, the “grouping graphics having connection relationships” in the S500, comprises following steps of:
S510—establishing a new group;
S520—selecting anyone of ungrouped graphics and adding the same to the new group established in S510;
S530—finding all graphics connected with the graphic added in the new group in S520 and adding the same to the new group;
S540—judging whether there is a graphic that needs to be added, if no, finishing establishing the new group and executing S550; and if any, continuing to execute S530; and
S550—judging whether there is a graphic that has not been included in the new group, if no, finishing grouping; and if any, going back to execute S510.

Preferably, “preprocessing all graphics” in the step (1) comprises traversing all vertices of any of the graphics and separately finding out smallest x coordinates, largest x coordinates, smallest y coordinates, and largest y coordinates, so as to form a bounding box of the graphic, referred to as bbox.

Preferably, the step (3) specifically comprises:
partitioning the graphic set bbox along the central x-axis of the graphic set bbox when a sum of amount of graphics in the two subsets partitioned along the central x-axis of the graphic set bbox is smaller than a sum of amount of graphics in the two subsets partitioned along the central y-axis of the graphic set bbox; and partitioning the graphic set bbox along the central y-axis of the graphic set bbox when a sum of amount of graphics in the two subsets partitioned along the central x-axis of the graphic set bbox is bigger than a sum of amount of graphics in the two subsets partitioned along the central y-axis of the graphic set bbox.

Preferably, in the step (4), when to continue to partition the two subsets partitioned is possible, going to the step (2), specifically comprising putting graphics in the subsets which are able to be partitioned together to generate a graphic set and calculating a bbox of the graphic set.

Preferably, separately judging whether to continue to partition the two subsets partitioned is possible in the step (2) specifically refers to terminate partitioning when purpose of simplifying the graphic set bbox cannot be achieved regardless of partitioning along the central x-axis or y-axis.

Preferably, in the step (8), the step (7) is continually executed when the final parent set is different from the graphic set generated by putting all original graphics together.

### 3. Beneficial Effects

Compared with the prior art, the technical solutions provided by the present invention has following beneficial effects.

A method for reconstructing physical connection relationships of general EDA model layouts of the present invention comprises: separately establishing interconnection relationships between stack layers in an EDA model, connection relationships of graphics on each stack layer, and connection relationships of graphics on interconnected stack layers; summarizing the connection relationships established, and then establishing connection relationships of all graphics of an overall EDA model; and separately establishing physical connection relationships of interconnected graphics in each group to obtain physical connection relationships of the overall EDA model layout. The determination of connection relationships of the EDA model is converted into the determination of intersection relationships of pure two-dimensional graphics, and temporal complexity of the two-dimensional graphic intersection relationships is lowered by means of a divide-and-conquer algorithm, thereby fulfilling the objective of quickly establishing connection relationships, solving the problem that specific link information cannot be accurately extracted from a model in layout pre-processing during a simulation process, and ensuring that users extract complete signals or power smoothly.

### BRIEF DESCRIPTION OF THE DRAWINGS

FIG. 1 is a method flowchart of the present invention;

FIG. 2 is a flow chart of establishing connection relationships between graphics in the present invention; and

FIG. 3 is a flow chart of grouping graphics in the present invention.

### SPECIFIC EMBODIMENTS

In order to facilitate the understanding of the present invention, the present invention will be described more fully below with reference to the accompanying drawings, in which several embodiments of the present invention are shown, however, the present invention can be realized in many different forms and is not limited herein. Rather, the purpose of providing these embodiments is to make the disclosure of the present invention more thorough and comprehensive.

It should be noted that when an element is said to be “fixed on” another element, it may be directly on the other element or there may be an intervening element; when an element is said to be “connected” to another element, it may is directly connected to another element or there may also be an intervening element; the terms “vertical,” “horizontal,” “left,” “right,” and similar expressions are used herein for purposes of illustration only.

Unless otherwise defined, all technical and scientific terms used herein have the same meanings as commonly understood by those skilled in the technical field of the present invention. The terms used herein in the description of the present invention are only for the purpose of describing specific embodiments, and are not intended to limit the present invention; the term “and/or” used herein includes one or more related listed items any and all combinations.

### Embodiment 1

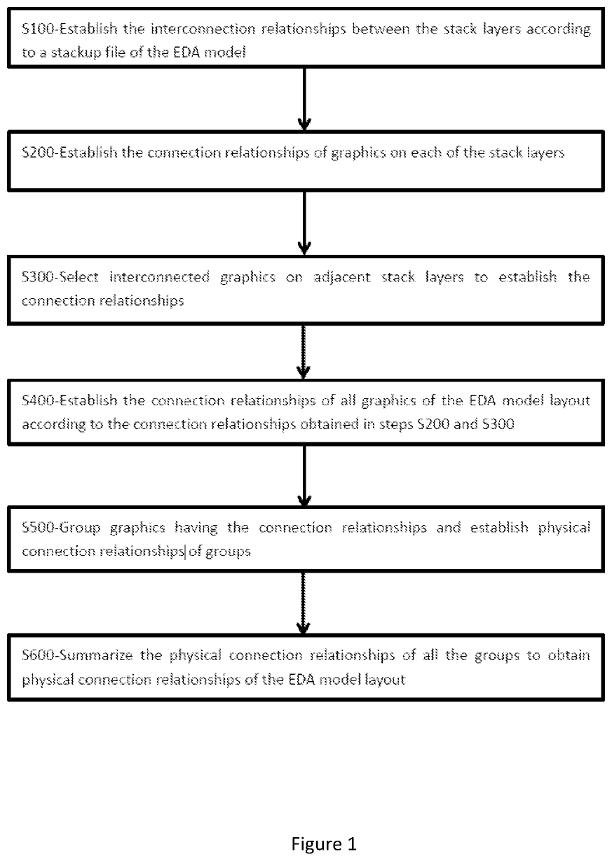

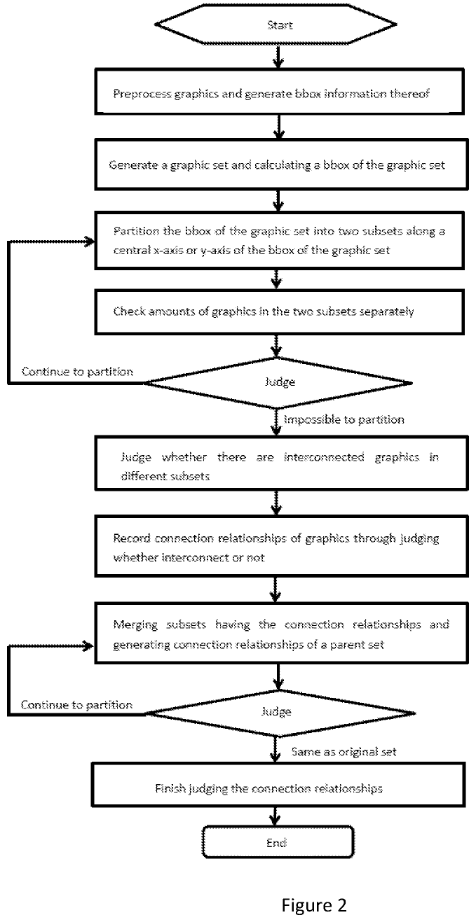

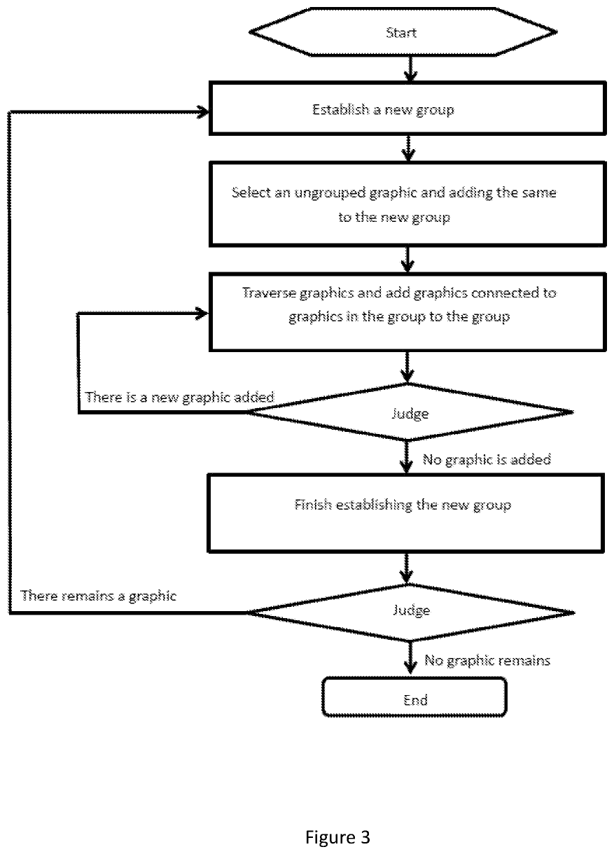

Please refer to FIGS. 1-3, the present embodiment provides a method for reconstructing physical connection relationships of general EDA model layouts comprises: separately establishing interconnection relationships between stack layers in an EDA model, connection relationships of graphics on each stack layer, and connection relationships of graphics on interconnected stack layers; summarizing the connection relationships established, and then establishing connection relationships of all graphics of an overall EDA model; and separately establishing physical connection relationships of interconnected graphics in each group to obtain physical connection relationships of the overall EDA model layout. The determination of connection relationships of the EDA model is converted into the determination of intersection relationships of pure two-dimensional graphics, and temporal complexity of the two-dimensional graphic intersection relationships is lowered by means of a divide-and-conquer algorithm, thereby fulfilling the objective of quickly establishing connection relationships, solving the problem that specific link information cannot be accurately extracted from a model in layout pre-processing during a simulation process, and ensuring that users extract complete signals or power smoothly.

The method for reconstructing physical connection relationships of general EDA model layouts of the present embodiment comprises following steps of:
S100—establishing interconnection relationships between stack layers according to a stackup file of an EDA model;
S200—establishing graphic connection relationships of graphics on each stack layer;
S300—selecting interconnected graphics on adjacent stack layers to establish graphic connection relationships;
S400—establishing connection relationships of all graphics of an overall EDA model layout according to the connection relationships obtained in steps S200 and S300;
S500—grouping graphics having connection relationships and establishing physical connection relationships of groups; and
S600—summarizing the physical connection relationships of all the groups to obtain physical connection relationships of the overall EDA model layout.

In technical solutions of the present embodiment, interconnection relationships between stack layers in an EDA model, connection relationships of graphics on each stack layer, and connection relationships of graphics on interconnected stack layers are separately established, then the established connection relationships are summarized, so as to obtain physical connection relationships of the EDA model.

The connection relationships of all graphics in steps S200 and S300 are established specifically through following steps of:
step (1)—preprocessing all graphics and calculating bounding boxes of all graphics, referred to as bbox;
step (2)—putting all graphics together to generate a graphic set and calculating a graphic set bbox;
step (3)—partitioning the graphic set bbox into two subsets along a central x-axis or y-axis of the graphic set bbox in a partitioning manner that a sum of amount of graphics in the two subsets after being partitioned reaches a minimum value;
step (4)—separately judging whether it is possible to continue to partition the two subsets partitioned, if yes, skipping to step (2) to continue the partitioning; and if no, executing step (5);
step (5)—judging whether there are interconnected graphics in different subsets, if yes, recording relationships of intersected subsets, and obtaining connection relationships of the subsets after judging and recording relationships of all intersected subsets;
step (6)—merging subsets having connection relationships and generating connection relationships of parent sets;
step (7)—judging whether there is a parent set connecting to other subsets, if yes, continuing to merge until generating a final parent set that connects to no subset; and
step (8)—finishing merging all subsets when the final parent set overlaps the graphic set generated by putting all original graphics together, i.e., finishing establishing connection relationships.

The “grouping graphics having connection relationships” in the S500, comprises following steps of:
S510—establishing a new group;
S520—selecting anyone of ungrouped graphics and adding the same to the new group established in S510;
S530—finding all graphics connected with graphics in the new group of S520 and adding the same to the new group;
S540—judging whether there is a graphic that needs to be added, if none, finishing establishing the new group and executing S550; and if any, continuing to execute S530; and
S550—judging whether there is a graphic that does not included in the new group, if none, finishing grouping; and if any, going back to execute S510, wherein the “preprocessing all graphics” in the step (1) comprises traversing all vertices of the graphics and separately finding out smallest x coordinates, largest x coordinates, smallest y coordinates, and largest y coordinates, so as to form bounding boxes of the graphics, referred to as bbox.

The step (3) specifically comprises:
partitioning the graphic set bbox along the central x-axis of the graphic set bbox when a sum of amount of graphics in the two subsets partitioned along the central x-axis of the graphic set bbox is smaller than a sum of amount of graphics in the two subsets partitioned along the central y-axis of the graphic set bbox; and partitioning the graphic set bbox along the central y-axis of the graphic set bbox when a sum of amount of graphics in the two subsets partitioned along the central x-axis of the graphic set bbox is bigger than a sum of amount of graphics in the two subsets partitioned along the central y-axis of the graphic set bbox.

A partition manner with a smaller sum of amount of graphics is selected, which can partition the graphic set into small subsets faster and complete the entire partition process faster

In the step (4), when it is possible to continue to partition the two subsets partitioned, the step (2) is executed, specifically comprising putting graphics in the subsets which are able to be partitioned together to generate a graphic set and calculating a graphic set bbox.

The “separately judging whether it is possible to continue to partition the two subsets partitioned” in the step (4) specifically refers to terminate partitioning when purpose of simplifying the graphic set bbox cannot be achieved regardless of partitioning along the central x-axis or y-axis.

In the step (8), the step (7) is continually executed when the final parent set is different from the graphic set generated by putting all original graphics together.

The above-mentioned embodiment only expresses a certain implementation mode of the present invention, and its description is relatively specific and detailed, but it should not be interpreted as limiting the patent scope of the present invention

It should be noted that for those of ordinary skill in the art, without departing from conception of the present invention, several modifications and improvements can also be made, and these all belong to the protection scope of the present invention; therefore, the protection scope for the present invention should be based on the appended claims.

1. A method for reconstructing physical connection relationships of general EDA model layouts comprising: separately establishing interconnection relationships between stack layers in an EDA model, connection relationships of graphics on each stack layer, and connection relationships of graphics on interconnected stack layers; summarizing the connection relationships established, and then establishing the connection relationships of all graphics in the EDA model; and separately establishing physical connection relationships of interconnected graphics in each group to obtain physical connection relationships of an EDA model layout.

2. The method for reconstructing physical connection relationships of general EDA model layouts according to claim 1, comprising following steps of:
S100—establishing the interconnection relationships between the stack layers according to a stackup file of the EDA model;
S200—establishing the connection relationships of graphics on each of the stack layers;
S300—selecting interconnected graphics on adjacent stack layers to establish the connection relationships;
S400—establishing the connection relationships of all graphics of the EDA model layout according to the connection relationships obtained in steps S200 and S300;
S500—grouping graphics having the connection relationships and establishing physical connection relationships of groups; and
S600—summarizing the physical connection relationships of all the groups to obtain physical connection relationships of the EDA model layout.

3. The method for reconstructing physical connection relationships of general EDA model layouts according to claim 2, wherein the connection relationships of all graphics in steps S200 and S300 are established specifically through following steps of:
step (1)—preprocessing all graphics and calculating bounding boxes of all graphics, referred to as bbox;
step (2)—putting all graphics together to generate a graphic set and calculating a bbox of the graphic set;
step (3)—partitioning the bbox of the graphic set into two subsets along a central x-axis or y-axis of the bbox of the graphic set in a partitioning manner that a sum of amount of graphics in the two subsets after being partitioned reaches a minimum value;
step (4)—separately judging whether to continue to partition the two subsets partitioned is possible, if yes, skipping to step (2) to continue partitioning; and if no, executing step (5);
step (5)—judging whether there are interconnected graphics in different subsets, if yes, recording relationships of intersected subsets, and obtaining connection relationships of the subsets after judging and recording relationships of all the intersected subsets;
step (6)—merging subsets having the connection relationships and generating the connection relationships of a parent set;
step (7)—judging whether the parent set is connecting to other sets or subsets, if yes, continuing to merge until generating a final parent set that connects to no set or subset; and
step (8)—finishing merging all subsets when the final parent set overlaps the graphic set generated by putting all original graphics together, finishing establishing the connection relationships.

4. The method for reconstructing physical connection relationships of general EDA model layouts according to claim 2, wherein grouping graphics having connection relationships in the S500, comprises following steps of:
S510—establishing a new group;
S520—selecting any of ungrouped graphics and adding the same to the new group established in S510;
S530—finding all graphics connected to the graphic in the new group formed in step S520 and adding the same to the new group;
S540—judging whether there is a graphic that needs to be added, if none, finishing establishing the new group and executing S550; and if any, continuing to execute S530; and
S550—judging whether there is a graphic that has not been included in the new group, if none, finishing grouping; and if any, going back to execute S510.

5. The method for reconstructing physical connection relationships of general EDA model layouts according to claim 3, wherein preprocessing all graphics in the step (1) comprises traversing all vertices of the graphics and separately finding out smallest x coordinates, largest x coordinates, smallest y coordinates, and largest y coordinates, so as to form bounding boxes of the graphics, referred to as bbox.

6. The method for reconstructing physical connection relationships of general EDA model layouts according to claim 3, wherein the step (3) specifically comprises:
Partitioning the bbox of the graphic set along the central x-axis of the bbox of the graphic set when a sum of amount of graphics in the two subsets partitioned along the central x-axis of the bbox of the graphic set is smaller than a sum of amount of graphics in the two subsets partitioned along the central y-axis of the bbox of the graphic set; and
partitioning the bbox of the graphic set along the central y-axis of the bbox of the graphic set when a sum of amount of graphics in the two subsets partitioned along the central x-axis of the bbox of the graphic set is bigger than a sum of amount of graphics in the two subsets partitioned along the central y-axis of the bbox of the graphic set.

7. The method for reconstructing physical connection relationships of general EDA model layouts according to claim 3, wherein in the step (4), when to continue to partition the two subsets partitioned is still possible, going to the step (2), specifically comprising putting graphics in the subsets which are able to be partitioned together to generate a graphic set and calculating a bbox of the graphic set.

8. The method for reconstructing physical connection relationships of general EDA model layouts according to claim 3, wherein separately judging whether it is possible to continue to partition the two subsets partitioned in the step (2) specifically refers to terminate partitioning when purpose of simplifying the graphic set cannot be achieved regardless of partitioning along the central x-axis or y-axis.

9. The method for reconstructing physical connection relationships of general EDA model layouts according to claim 3, wherein in the step (8), the step (7) is continually executed when the final parent set is different from the graphic set generated by putting all original graphics together.
